(19) United States
(12) Patent Application Publication
(10) Pub. No.: US 2009/0105395 A1
(43) Pub. Date: Apr. 23, 2009

(54) CURABLE RESIN COMPOSITION

(75) Inventors: Hirotoshi Kamata, Kanagawa (JP); Shoji Nishiguchi, Gunma (JP); Daisuke Yaginuma, Gunma (JP); Atsushi Sakamoto, Gunma (JP); Aziz Mansurovich Muzafarov, Moscow (RU); Nadezhda Andreevna Tebeneva, Moscow (RU); Viktor Davidovich Myakushev, Moscow (RU); Natalia Georgievna Vasilenko, Moscow (RU); Ekaterina Parshina, Moscow (RU); Ivan Borisovich Meshkov, Moscow (RU)

Correspondence Address: OBLON, SPIVAK, MCCLELLAND MAIER & NEUSTADT, P.C., 1940 DUKE STREET, ALEXANDRIA, VA, 22314, US

(73) Assignees: Enikolopov Inst of Synth Poly, Moscow (RU); Showa Highploymer co., Ltd, TOkyo (JP)

(21) Appl. No.: 12/297,466

(22) PCT Filed: Apr. 17, 2007
(86) PCT No.: PCT/JP2007/058371

§ 371 Date: Oct. 17, 2008

(30) Foreign Application Priority Data
Apr. 25, 2006 (RU) 2006113774

(51) Int. Cl. C08L 83/04; C08G 77/04

(52) U.S. Cl. 524/502; 526/279; 525/185

(57) ABSTRACT

The present invention is directed to a novel functional polyorganosiloxane having on average two or more vinyl groups in one molecule thereof.

The polyorganosiloxane is represented by the following formula (I):

(R²₃SiO_{1/2})ₐ(Ph₂SiO_{2/2})_{b}(R¹SiO_{3/2})_{c}(PhSiO_{3/2})_{d}(R¹R²SiO_{2/2})ₑ (I)

(wherein “a” to “e” represent compositional proportions by mole, satisfying the conditions: 0.15≦a≦0.4, 0.1≦b≦0.2, 0.15≦c≦0.4, 0.2≦d≦0.4, 0≦e≦0.2, and “a+b+c+d+e”=1; R¹ represents a vinyl group; R² represents a methyl group or a phenyl group; and Ph denotes a phenyl group) and is produced through polycondensation of an alkoxysilane mixture in the presence of an active solvent.

The present invention also relates to a curable resin composition containing the polyorganosiloxane, which composition is suitably employed for encapsulating optical devices such as LEDs, photo-sensors, and lasers as well as optical materials.

The invention further relates to a composition for encapsulating an LED suitable for encapsulating LEDs emitting blue to UV light and white light-emitting devices.

### TECHNICAL FIELD

The present invention relates to a polyorganosiloxane for providing a cured product having high refractive index, high heat resistance, and high weather resistance, which characteristics are desired for encapsulating optical devices such as LEDs (hereinafter may be referred to as light-emitting devices), photo-sensors, and lasers as well as optical materials of general use; to a curable resin composition containing the polyorganosiloxane; to a composition for encapsulating an LED, which provides a cured product having high heat resistance and light resistance, which characteristics are desired for encapsulating, among others, LEDs emitting blue to UV light and white light-emitting devices and which composition can be readily handled; and to an optical device encapsulated with the curable resin composition.

### BACKGROUND ART

The field of optical devices has been remarkably developed in recent years. Among such optical devices, LEDs have found a wider variety of uses year by year by virtue of their excellent characteristics such as long service life, high luminance, and low electric power consumption. In particular, recent year's development of blue-light-emitting LEDs (hereinafter referred to as blue-light LEDs) and UV-emitting LEDs (hereinafter referred to as UV LEDs) has rapidly increased use of such LEDs in illumination light sources, display devices, backlight of liquid-crystal displays, and similar devices.

Hitherto, an epoxy resin has been generally employed as an encapsulating material for LEDs, since the epoxy resin has excellent strength and high transmittance (see, for example, Patent Documents 1 to 3). However, a semiconductor chip including an LED which emits light having a wavelength of about 350 nm to about 500 nm; e.g., a blue-light LED or a UV LED, generates a large amount of heat, and a short-wavelength light is emitted therefrom. Therefore, an optically transparent encapsulating part made of such an epoxy resin is rapidly discolored by deterioration of the epoxy resin. As a result, the thus-discolored resin absorbs the light emitted from the semiconductor chip, thereby reducing the light transmitting therethrough and luminance of LEDs within a short period of time.

Another known LED encapsulating material is a silicone resin. A silicone-based encapsulating material, which has excellent transparency, weather resistance, and heat resistance, has become more popular for use in blue-light LEDs and UV LEDs, which per se impair an epoxy resin-based encapsulating material.

Currently employed silicone-based encapsulating materials are generally formed of a composition containing a polyorganosiloxane having an alkenyl-group, a hydrogen polyorganosiloxane, a hydrosilylation catalyst, and a curing-modulator. Through thermally curing such a composition, a gel-form or rubber-like elastomer is formed, whereby an LED encapsulating material is provided (see, for example, Patent Documents 4 and 5). However, as the luminance of LEDs and the heat generated from such LEDs have increased, an encapsulating material formed from a silicone resin is gradually discolored during use. Thus, there are demands for further improvement in heat resistance and light resistance of silicone resin.

Patent Document 1: JP (kokai) No. 2003-176334

Patent Document 2: JP (kokai) No. 2003-26763

Patent Document 3: JP (kokai) No. 2003-277473

Patent Document 4: JP (kokai) No. 3-22553

Patent Document 5: JP (kokai) No. 3-166262

### DISCLOSURE OF THE INVENTION

### Problems to be Solved by the Invention

A first object of the present invention for overcoming the aforementioned technical drawbacks is to provide a polyorganosiloxane suitable for encapsulating an optical device, particularly a blue-light LED or a UV LED, which polyorganosiloxane forms a cured product having excellent transparency, high refractive index, weather resistance, heat resistance, and well-balanced hardness and strength. A second object of the invention is to provide a curable resin composition containing the polyorganosiloxane and an optical device encapsulated with the curable resin composition.

Further, a third object of the invention is to provide a silicone-based encapsulating material being excellent in transparency, heat resistance, light resistance, and workability, for serving as an encapsulating material for LEDs, particularly blue-light LEDs and UV LEDs, and an LED encapsulated with the encapsulating material.

In order to attain the aforementioned objects, the present inventors have carried out extensive studies, and have found that a curable resin composition which forms a cured product having excellent transparency, high refractive index, weather resistance, heat resistance, and well-balanced hardness and strength can be produced from a polyorganosiloxane having specific structural units and specific average compositional proportion, and that an optical device encapsulated with the resin composition can be provided. The inventors have also found that a composition for encapsulating an LED having excellent workability, which composition forms a cured product excellent in transparency, light resistance, and heat resistance can be produced from a composition containing a polyorganosiloxane mixture having specific structural units, a polyorgano-hydrogen-polysiloxane mixture, and an addition reaction catalyst in specific compositional proportion, and that an LED encapsulated with the composition can be produced. The present invention has been accomplished on the basis of these findings.

### Means for Solving the Problems

Accordingly, the present invention provides the following.

(1) A polyorganosiloxane having on average two or more vinyl groups in one molecule thereof and represented by the following formula (I), which indicates structural units and average compositional proportion:

(R²₃SiO_{1/2})ₐ, (Ph₂SiO_{2/2})_{b}, (R¹SiO_{3/2})_{c}, (PhSiO_{3/2})_{d}, (R¹R²SiO_{2/2})ₑ (I)

(wherein “a” to “e” represent compositional proportion by mole, satisfying the conditions: 0.15≦a≦0.4, 0.1≦b≦0.2, 0.15≦c≦0.4, 0.2≦d≦0.4, 0≦e≦0.2, and “a+b+c+d+e”=1; R¹ represents a vinyl group; R² represents a methyl group or a phenyl group; and Ph denotes a phenyl group).

(2) A polyorganosiloxane as described in the above (1), which is produced through condensation of an alkoxysilane mixture represented by the following formula (II):

R²₃SiOR, Ph₂Si(OR)₂, R¹Si(OR)₃, PhSi(OR)₃ (II)

[wherein R¹ represents a vinyl group, R² represents a methyl group or a phenyl group, R¹ represents a C1 to C6 alkyl group, and Ph denotes a phenyl group] in an active solvent.
(3) A polyorganosiloxane as described in the above (2),
wherein the active solvent is a carboxylic acid in the form of a sole component or a mixture of a carboxylic acid and one or more solvents selected from among an aliphatic carboxylic acid ester, an ether, an aliphatic ketone, and an aromatic solvent.
(4) A polyorganosiloxane containing a first polyorganosiloxane as described in any one of the above (1) to (3) and a second polyorganosiloxane, said second polyorganosiloxane being produced through condensation of an alkoxysilane mixture selected from among the alkoxysilane mixtures represented by formula (II) such that the compositional proportion of structural units of the second polyorganosiloxane differs from those given in formula (I).
(5) A polyorganosiloxane as described in any one of the above (2) to (4), wherein the condensation is performed at temperatures of 20 to 150° C.
(6) A polyorganosiloxane as described in any one of the above (2) to (5), wherein the condensation is performed in the presence of acetyl chloride as a catalyst.
(7) A polyorganosiloxane as described in any one of the above (2) to (6), wherein end silanol groups are terminated with one or more silane compounds selected from among hexamethyldisilazane, trimethylchlorosilane, triethylchlorosilane, triphenylchlorosilane, and dimethylvinylchlorosilane.
(8) A polyorganosiloxane as described in any one of the above (2) to (6), wherein the ratio of carboxylic acid to organic solvent employed as the active solvent is 1:10 to 10:1 (ratio by mass).
(9) A curable resin composition comprising (A) a polyorganosiloxane as described in any one of the above (1) to (8), (B) a polyorgano-hydrogen-polysiloxane having on average two or more hydrogen atoms connected to a silicon atom in one molecule thereof, and (C) a hydrosilylation catalyst.
(10) A curable resin composition as described in the above (9), wherein the polyorgano-hydrogen-polysiloxane which is the component (B) contains (CH₃)₂SiHO_{1/2} unit and/or CH₃SiHO_{2/2} unit.
(11) A curable resin composition as described in the above (9) or (10), wherein the polyorgano-hydrogen-polysiloxane which is the component (B) has at least one phenyl group in one molecule thereof.
(12) A curable resin composition as described in any one of the (9) to (11), wherein the amount of component (B) with respect to component (A) is such that the ratio by mole of hydrogen atoms connected to a silicon atom in component (B) to vinyl groups in component (A) is adjusted to 0.5 to 2.0.
(13) A curable resin composition as described in any one of the above (9) to (12), wherein the hydrosilylation catalyst which is the component (C) is a platinum-group metal catalyst.
(14) A curable resin composition as described in any one of the above (9) to (13), which forms a cured product having a refractive index of 1.5 or higher.
(15) A curable resin composition as described in any one of the above (9) to (14), which is prepared for encapsulating an LED.
(16) An optical device encapsulated with a curable resin composition as described in any one of the above (9) to (15).
(17) An optical device as described in the above (16), which is an LED.
(18) A composition for encapsulating an LED, comprising:

(X) a polyorganosiloxane mixture having on average two or more vinyl groups in one molecule thereof and represented by the following formula (III), which indicates structural units and average compositional proportion:

(R³₃SiO_{1/2})_{f}, (R⁴₂SiO_{2/2})_{g}, (R⁵SiO_{3/2})ₕ, (CH═CH₂SiO_{3/2})ᵢ, (CH═CH₂(CH₃)₂SiO_{1/2})ⱼ (III)

(wherein “f” to “j” represent compositional proportion by mole, satisfying the conditions: 0.05≦f≦0.25, 0.05≦g≦0.15, 0.30≦h≦0.65, 0.05≦I≦0.25, 0.05≦j≦0.25, and “f+g+h+I+j”=1; and R³ to R⁵, which may be identical to or different from one another, each represent a methyl group or a phenyl group);

(Y) a polyorgano-hydrogen-polysiloxane mixture having on average two or more hydrogen atoms connected to a silicon atom in one molecule thereof, and

(Z) an addition reaction catalyst.

(19) A composition for encapsulating an LED as described in the above (18), wherein the ratio “I”:“j” in component (X) is 1:4 to 4:1.
(20) A composition for encapsulating an LED as described in the above (18) or (19), wherein the amount of component (Y) with respect to component (X) is such that the ratio by mole of silicon-atom-bound hydrogen atoms in component (Y) to vinyl groups in component (X) is adjusted to 0.8 to 1.2.
(21) A composition for encapsulating an LED described in any one of the above (18) to (20), wherein the addition reaction catalyst which is the component (Z) is a platinum-group metal catalyst.
(22) An LED encapsulated with a composition for encapsulating an LED described in any one of the above (18) to (21).

### EFFECTS BY THE INVENTION

According to the present invention, there can be provided a polyorganosiloxane suitable for encapsulating an optical device, particularly a blue-light LED or a UV LED, which polyorganosiloxane forms a cured product having excellent transparency, high refractive index, weather resistance, heat resistance, and well-balanced hardness and strength, a curable resin composition containing the polyorganosiloxane, and an optical device encapsulated with the curable resin composition.

Further, a silicone-based encapsulating material being excellent in transparency, heat resistance, light resistance, and workability, for serving as an encapsulating material for LEDs, particularly blue-light LEDs and UV LEDs, and an LED encapsulated with the encapsulating material can be provided.

### BRIEF DESCRIPTION OF THE DRAWINGS

FIG. 1 A GPC curve of polyorganosiloxane produced in Example 1.

FIG. 2 An ¹H-NMR chart of polyorganosiloxane produced in Example 3.

FIG. 3 An IR chart of polyorganosiloxane produced in Example 3.

### BEST MODES FOR CARRYING OUT THE INVENTION

Hereinafter, the present invention will be described in detail.

Firstly, the polyorganosiloxane according to the present invention will be described in detail.

The polyorganosiloxane according to the present invention is a compound having on average two or more vinyl groups in one molecule thereof and represented by the following formula (I), which indicates structural units and average compositional proportion thereof:

(R²₃SiO_{1/2})ₐ, (Ph₂SiO_{2/2})_{b}, (R¹SiO_{3/2})_{c}, (PhSiO_{3/2})_{d}, (R¹R²SiO_{2/2})ₑ (I).

In formula (I), R¹ represents a vinyl group, and R² represents a methyl group or a phenyl group, and “a” to “e” represent compositional proportion by mole, satisfying the conditions: 0.15≦a≦0.4, 0.1≦b≦0.2, 0.15≦c≦0.4, 0.2≦d≦0.4, 0≦e≦0.2, and “a+b+c+d+e”=1. Under these conditions, desired physical properties for serving as an encapsulating material are ensured. Ph denotes a phenyl group.

When “a” is less than 0.15, the polyorganosiloxane produced has an excessive molecular weight, thereby increasing the viscosity and decreasing workability for encapsulating, whereas when “a” is in excess of 0.4, the molecular weight is so small that the cured product thereof becomes brittle.

When “b” is less than 0.1, the cured product produced therefrom has a reduced refractive index, whereas when “b” is in excess of 0.2, light resistance decreases.

When “c” is less than 0.15, the cured product thereof has a reduced cross-linking degree, thereby making the product soft and sticky, whereas when “c” is in excess of 0.4, the cured product becomes hard and brittle.

When “d” is less than 0.2, the cured product thereof becomes soft and sticky, whereas when “d” is in excess of 0.4, the cured product becomes hard and brittle.

The proportion “e” serves as an index for controlling the curability of the polyorganosiloxane. Thus, when “e” is in excess of 0.2, curing rate increases, and the cured product is easily deformed, which is not suited for an LED encapsulating material.

As described above, when “a” to “e” fall considerably outside the aforementioned ranges, the cured product becomes hard and brittle, or soft and sticky, or light resistance or refractive index decreases. Thus, such cases are not suited for the resin to serve as an LED encapsulating material.

The polyorganosiloxane represented by formula (I) employed in the invention preferably has a molecular weight of about 500 to about 100,000, from the viewpoints of viscosity and compatibility with other components. The polyorganosiloxane may be used singly or in combination of two or more species.

The polyorganosiloxane represented by formula (I) of the present invention may be produced from organosilanes corresponding to the structural units, through hydrolysis and co-condensation. Generally, chlorosilanes such as trimethylchlorosilane, triethylchlorosilane, triphenylchlorosilane, tripropylchlorosilane, diphenyldichlorosilane, vinyltrichlorosilane, phenyltrichlorosilane, methyltrichlorosilane, and ethyltrichlorosilane are hydrolyzed in the presence of an acid catalyst such as hydrochloric acid, to thereby synthesize the polyorganosiloxane. Preferably, an alkoxysilane mixture represented by the following formula (II):

R²₃SiOR, Ph₂Si(OR)₂, R¹Si(OR)₃, PhSi(OR)₃ (II)

is subjected to condensation in an active solvent.

The general reaction scheme is as follows:

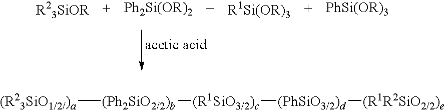

(wherein “a” to “e” have the same definitions as mentioned in relation to formula (I)).

In formula (II) and the reaction scheme, R¹ represents a vinyl group, R² represents a methyl group or a phenyl group, and R represents a C1 to C6 alkyl group. Examples of group R include methyl, ethyl, propyl, isopropyl, n-butyl, isobutyl, t-butyl, pentyl, isopentyl, neopentyl, hexyl, isohexyl, and cyclohexyl. Among them, methyl is preferred, from the viewpoints of availability and reactivity. Ph denotes a phenyl group.

Examples of the alkoxysilane represented by formula (II) include trimethylmethoxysilane, trimethylethoxysilane, trimethylpropoxysilane, triphenylmethoxysilane, triphenylethoxysilane, diphenyldimethoxysilane, diphenyldiethoxysilane, vinyltrimethoxysilane, vinyltriethoxysilane, phenyltrimethoxysilane, and phenyltriethoxysilane.

The active solvent employed in the invention may be a carboxylic acid in the form of a sole component or a mixture of a carboxylic acid and one or more solvents selected from among an aliphatic carboxylic acid ester, an ether, an aliphatic ketone, and an aromatic solvent. Examples of the carboxylic acid include formic acid, acetic acid, propionic acid, and benzoic acid. Examples of the aliphatic carboxylic acid ester solvent include ethyl formate, propyl formate, butyl formate, methyl acetate, ethyl acetate, propyl acetate, butyl acetate, methyl propionate, ethyl propionate, propyl propionate, and butyl propionate. Examples of the ether include diethyl ether, methyl ethyl ether, methyl propyl ether, ethylene glycol dimethyl ether, diisopropyl ether, tetrahydrofuran, dioxane, and dioxorane. Examples of the aliphatic ketone solvent include acetone, methyl ethyl ketone, methyl isobutyl ketone, diisobutyl ketone, cyclopentanone, and cyclohexanone. Examples of the aromatic solvent include benzene, toluene, xylene, ethylbenzene, chlorobenzene, and dichlorobenzene. Among them, acetic acid as a single component, or a mixture of acetic acid, methyl ethyl ketone, and/or toluene is preferably used. In order to completely progress condensation reaction, the carboxylic acid is generally used in an amount by mole 1.0 to 5.0 times, preferably 1.2 to 3.0 times the total amount of starting alkoxysilanes. The ratio of carboxylic acid to organic solvent is preferably 1:10 to 10:1.

The reaction temperature at which the polyorganosiloxane represented by formula (I) of the present invention is synthesized varies depending on the type of solvent and starting materials employed in the reaction. However, the temperature is generally 20° C. to 150° C., preferably 50° C. to 120° C. For shortening the reaction time, an acid chloride such as acetyl chloride, propionyl chloride, or benzoyl chloride, or a silyl chloride such as trimethylsilyl chloride or triethylsilyl chloride may be employed as a catalyst. Of these, acetyl chloride is preferably employed. The catalyst may be used in an amount of 0.01 to 0.5% by mass with respect to the reaction mixture.

In the polyorganosiloxane represented by formula (I) of the present invention, an end silanol group, which might adversely affect the stability of the compound and physical properties of the cured product, may be terminated with one or more silane compounds selected from among hexamethyldisilazane, trimethylchlorosilane, triethylchlorosilane, triphenylchlorosilane, and dimethylvinylchlorosilane.

Subsequently, the curable resin composition according to the present invention will be described.

The curable resin composition according to the present invention comprises (A) the polyorganosiloxane represented by formula (I), (B) a polyorgano-hydrogen-polysiloxane having on average two or more hydrogen atoms connected to a silicon atom in one molecule thereof, and (C) a hydrosilylation catalyst. The composition serves as an encapsulating material.

The polyorgano-hydrogen-polysiloxane, component (B) of the curable resin composition of the present invention, serves as a cross-linking agent during hydrosilylation with the component (A) for curing the composition and is a polyorgano-hydrogen-polysiloxane having on average two or more silicon-atom-bound hydrogen atoms in one molecule thereof. Preferably, the polyorgano-hydrogen-polysiloxane employed in the invention contains (CH₃)₂SiHO_{1/2} unit and/or CH₃SiHO_{2/2} unit and has at least one phenyl group in one molecule thereof.

Examples of the polyorgano-hydrogen-polysiloxane include 1,1,3,3-tetramethyldisiloxane, 1,3,5,7-tetramethylcyclotetrasiloxane, 1,1,3,3-tetraphenyldisiloxane, 1,3,5,7-tetraphenylcyclotetrasiloxane, trimethylsiloxy group-both-end-terminated methylhydrogen polysiloxane, trimethylsiloxy group-both-end-terminated dimethylsiloxane-methylhydrogensiloxane copolymer, dimethylhydrogensiloxy group-both-end-terminated dimethylpolysiloxane, dimethylhydrogensiloxy group-both-end-terminated dimethylsiloxane-methylhydrogensiloxane copolymer, dimethylhydrogensiloxy group-both-end-terminated methylhydrogensiloxane-phenylmethylsiloxane copolymer, trimethylsiloxy group-both-end-terminated methylhydrogensiloxane-diphenylsiloxane copolymer, trimethylsiloxy group-both-end-terminated methylhydrogensiloxane-diphenylsiloxane-dimethylsiloxane copolymer, a copolymer formed from (CH₃)₂HSiO_{1/2} unit and SiO_{4/2} unit, and a copolymer formed from (CH₃)₂HSiO_{1/2} unit and (C₆H₅) SiO_{3/2} unit.

When the amount of polyorgano-hydrogen-polysiloxane (component (B)) is regulated such that the ratio by mole of hydrogen atoms connected to a silicon atom in component (B) to all the vinyl groups in component (A) is adjusted to 0.5 to 2.0, preferably 0.8 to 1.5, a cured product of desired quality can be produced.

The hydrosilylation catalyst, which is component (C) of the curable resin composition of the present invention, is a catalyst which is generally used to accelerate hydrosilylation between a hydrogen-atom-bound silicon atom and a hydrocarbon having a multiple bond. In the present invention, the catalyst is used to accelerate hydrosilylation between a vinyl group in component (A) and SiH group in component (B).

The hydrosilylation catalyst, serving as component (C), is preferably a platinum-group metal catalyst. Examples of the catalyst include metals such as platinum, rhodium, palladium, ruthenium, and iridium, and compounds of thereof. Of these, platinum and a platinum compound are preferably used. Examples of the platinum compound include platinum halogen compounds such as PtCl₄, H₂PtCl₄6H₂O, Na₂PtCl₄4H₂O, a reaction product between H₂PtCl₄6H₂O and cyclohexane; and platinum complexes such as platinum-1,3-divinyl-1,1,3,3-tetramethyldisiloxane complex, bis-(γ-picoline)-platinum dichloride, trimethylenepyridine-platinum dichloride, dicyclopentadiene-platinum dichloride, cyclooctadiene-platinum dichloride, cyclopentadiene-platinum dichloride, bis(alkynyl)bis(triphenylphosphine)platinum complex, and bis(alkynyl)(cyclooctadiene)platinum complex.

Preferably, the hydrosilylation catalyst, serving as component (C), is used in an amount generally about 1 to about 500 ppm as reduced to platinum group metal(s) with respect to the total amount (mass) of components (A) and (B), particularly preferably about 2 to about 100 ppm.

Into the curable resin composition of the present invention, a variety of additives may be incorporated, so long as the additives do not impair the effects of the invention. For example, there may be employed a hydrosilylation reaction moderator for imparting desired curability and pot-life to the composition, a phosphor for white emission such as YAG, optional inorganic fillers and pigments such as silica microparticles and titanium oxide, organic fillers, metallic fillers, flame-retardants, heat-resisting agents, and oxidation-deterioration inhibitors.

Suitable curing conditions for yielding a desired cured product include a curing temperature of generally 30° C. to 200° C., preferably 80° C. to 150° C.; and a curing time of about 10 min to about 300 min. The curing temperature is selected from an appropriate range depending on the type of the catalyst employed.

In the case where the curable resin composition of the present invention is employed as an optical device encapsulating material, desirably, the composition is transparent so as to transmit light emitted from the device and has high refractive index so as to enhance the efficiency of extracting light from the light-emitting device. From another aspect, when cured, the composition has a certain level of hardness so as to reduce deformation or warpage of the encapsulating material; i.e., to prevent application of stress to the light-emitting device to the greatest possible extent, and is required to be crack-resistant so as to protect the device against shock. Furthermore, as mentioned above, the composition is required to have weather resistance and heat resistance to cope with high temperature at a light-emitting section. In addition to weather resistance and heat resistance for maintaining mechanical strength, other factors; for example, resistance to discoloring, are important, since optical transparency of the encapsulating material should not be impaired. The curable resin composition of the present invention sufficiently satisfies these required characteristics and, therefore, is effectively employed as an encapsulating composition for an optical device, particularly for an LED.

The encapsulated optical device of the present invention may be produced through coating a light-emitting device generally having a main emission peak at 550 nm or shorter with the curable resin composition of the present invention, followed by heating at a predetermined temperature for curing.

In this case, no particular limitation is imposed on the light-emitting device, so long as the light-emitting device generally has a main emission peak at 550 nm or shorter, and known LEDs may be employed. Particularly, nitride (GaN, InGaN, etc.)-based LEDs are preferred. Examples of such LEDs include those produced through stacking semiconductor material layers on a substrate optionally having a buffer layer (GaN, AlN, etc.), through a method such as MOCVD, HDVPE, or liquid-phase epitaxy. The substrate may be made of any material, and examples include single crystals of sapphire, spinel, SiC, Si, ZnO, and GaN. Of these, sapphire is preferably employed, since GaN having high crystallinity can be readily formed thereon, which is of high industrial value.

To such an LED, an electrode is attached through a known technique, and the attached electrode is electrically connected to a lead terminal or a similar part through various techniques. The electrical connection member preferably has appropriate properties; for example, good ohmic and mechanical connectability to an electrode of the light-emitting device, and an example of the connection member is bonding wire made of, for example, gold, silver, copper, platinum, aluminum, or an alloy thereof. Alternatively, a conductive adhesive formed of a resin containing a conductive filler such as silver or carbon may also be employed. Among them, aluminum wire and gold wire are preferably employed, from the viewpoint of good workability.

The lead terminal employed in the present invention is preferably excellent in properties such as electrical conductivity and connectability to an electrical connection member such as bonding wire. The lead terminal preferably has an electric resistance of 300 Ω·cm or lower, more preferably 3 μΩ·cm or lower. Examples of the material for the lead terminal include iron, copper, copper-iron, copper-tin, and those plated with silver, nickel, etc. In order to attain favorable light dispersion, the gloss of the lead terminal may be appropriately modified.

The encapsulated optical device of the present invention, particularly an LED package, may be produced through connecting an LED to an electrode, a lead terminal, etc., coating the product with the curable resin composition of the present invention, and heating the resin composition for curing. As used herein, the term “coating” refers not only to direct encapsulating of the LED but also to indirect coating. Specifically, an LED may be encapsulated with the curable resin composition of the present invention through various techniques conventionally employed in the art, or an LED may be encapsulated with glass or a conventional encapsulating resin such as epoxy resin, acrylic resin, urea resin, or imide resin, followed by over-coating the surface or the periphery of the pre-encapsulated product with the curable resin composition of the present invention. Alternatively, an LED may be encapsulated with the curable resin composition of the present invention, followed by molding with a conventionally employed material such as epoxy resin, acrylic resin, urea resin, or imide resin. Through employment of any of the aforementioned techniques, a variety of effects such as a lens effect can be imparted to the cured product based on the difference in refractive index or specific weight.

No particular limitation is imposed on the encapsulating method, and any technique can be employed. In one encapsulating procedure, the curable resin composition of the present invention in the form of liquid is poured into a cap, a cavity, a space in a package, or a similar container where an LED is placed at the bottom thereof, by means of a dispenser or by another means, followed by curing under the aforementioned heating conditions. In another encapsulating procedure, the curable resin composition of the present invention in the form of solid or high-viscosity liquid is, for example, heated to allow it to flow, and the flowable composition is poured into a space in a package or a like container, followed by treatment (e.g., heating) for curing. In this case, the package may be produced from a variety of materials, and examples of such materials include polycarbonate resin, poly(phenylene sulfide) resin, epoxy resin, acrylic resin, silicone resin, and ABS resin. In still another encapsulating procedure, the curable resin composition of the present invention is poured into a mold in advance, and a leadframe or a similar part onto which an LED has been fixed is immersed in the poured composition, followed by curing. In yet another encapsulating procedure, an encapsulating layer is formed in a mold into which an LED has been inserted, from the curable resin composition of the present invention through a technique such as pouring by means of a dispenser, transfer-molding, or injection molding, followed by curing.

In an alternative encapsulating procedure, the curable resin composition of the present invention which is in the form of liquid or in a flowable state is added dropwise or applied onto an LED, followed by curing. In a still alternative encapsulating procedure, the curable resin composition of the present invention is applied onto an LED through stencil printing or screen printing or through a mask so as to form an encapsulating layer, followed by curing. In a yet alternative encapsulating procedure, an LED is fixed on a member of a plate-shape, a lens-shape, etc. which has been formed from partial or complete curing of the curable resin composition of the present invention. Alternatively, the curable resin composition of the present invention may be employed as a die-bonding agent for fixing an LED onto a lead terminal or a package, or employed to form passivation film on an LED.

No particular limitation is imposed on the form of the coating part, and any form is acceptable. Examples of the form include lens-like, plate-like, thin film-like, and “a side surface of a light-emitting device cut at an acute angle along a direction perpendicular to the upper surface of a transparent substrate” as disclosed in JP (kokai) No. 6-244458. These shapes may be realized through shaping and curing the curable resin composition of the present invention, or through curing the curable resin composition of the present invention and then performing post-shaping.

The encapsulated optical device of the present invention; in particular, an LED package, may be of a variety of types. Examples include lamp, SMD, and chip. A package substrate for SMD and chip may be selected from a variety of materials such as epoxy resin, BT resin, and a ceramic material.

The encapsulated optical device of the present invention; in particular, an LED package, may be employed in a variety of known applications. Specific examples include backlight, illumination, a light source for a sensor, a light source for automobile indicators, a signal lamp, a display lamp, a display device, a light source of a plane-form light-emitting material, a display, a decoration, and various other lights.

Subsequently, the composition for encapsulating an LED according to the present invention (hereinafter, occasionally referred to simply as composition) will be described in detail.

A characteristic feature of the composition of the present invention resides in that the composition is a curable resin composition essentially containing the aforementioned components (X) to (Z) and an optional inorganic filler or a phosphor material as a sole additive.

Since the composition of the invention contains no conventionally employed organic additive such as a curing modulator, an antioxidant, or an adhesion-improver, and the ratio of vinyl groups in component (X) to silicon-atom-bound hydrogen atoms in component (Y) is optimized, the composition can provide a composition for encapsulating an LED exhibiting more excellent heat resistance and light resistance, as compared with conventional silicone-based LED encapsulating materials.

The polyorganosiloxane mixture, serving as component (X) of the composition of the present invention, is a compound having on average two or more vinyl groups in one molecule thereof and represented by the following formula (III), which indicates structural units and average compositional proportion:

(R³₃SiO_{1/2})_{f}, (R⁴₂SiO_{2/2})_{g}, (R⁵SiO_{3/2})ₕ, (CH═CH₂SiO_{3/2})_{I}, (CH═CH₂(CH₃)₂SiO_{1/2})ⱼ (III)

(wherein R³ to R⁵, which may be identical to or different from one another, each represent a methyl group or a phenyl group, and “f” to “j” represent compositional proportion by mole, satisfying the conditions: 0.05≦f≦0.25, 0.05≦g≦0.15, 0.30≦h≦0.65, 0.05≦I≦0.25, 0.05≦j≦0.25, and “f+g+h+I+j”=1). Under these conditions, physical properties desired for encapsulating material can be attained. When “f” to “j” considerably fall outside these ranges, for example, in the case where the proportion of vinyl group and R⁵SiO_{3/2} unit excessively increase, the cured product becomes hard but brittle, whereas when the proportion of R³₃SiO_{1/2} unit is in excess or that of vinyl group or R⁵SiO_{3/2} unit is too small, curing failure may readily occur.

In the present invention, the curability and pot-life of the composition is regulated not through addition of a curing modulator but through controlling the ratio of (CH═CH₂SiO_{3/2}) unit to (CH═CH₂(CH₃)₂SiO_{1/2}) unit; i.e., a ratio of “I” to “j” in formula (III). A study by the present inventors has revealed that since the rate of hydrosilylation (curing reaction) of the vinyl group in the (CH═CH₂SiO_{3/2}) unit considerably differs from that of the vinyl group in the (CH═CH₂(CH₃)₂SiO_{1/2}) unit, the curing rate can be controlled as desired through regulating the amounts of the two types of vinyl groups in the polyorganosiloxane, and that satisfactory curability and stability can be attained by controlling the “I”:“j” ratio preferably to 1:4 to 4:1. Thus, according to the present invention, a satisfactory pot-life of the composition can be attained, even though a conventional organic curing modulator, which is a possible discoloring substance remaining in a silicone resin cured product, is not added thereto.

The ratio “I”:“j” in component (X) can be determined as desired so as to fall within the range of 1:4 to 4:1, depending on the target curability suited for the purpose of use. When “I” is increased, curing proceeds slowly, whereas when “j” is increased, curing proceeds relatively speedy.

When the ratio “I”:“j” falls outside the above range, for example, in the case where “I” is excessively small, and “j” is excessively large, hydrosilylation readily occurs even at room temperature, readily leading to an increase in viscosity or gelation. In the case where “I” is excessive, and “j” is too small, the composition is stable at room temperature but exhibits low rate of curing reaction. The latter case is not preferred from the viewpoint of, for example, productivity, since curing must be performed at higher temperature or for a long period of time.

Component (X) may be produced through co-hydrolysis of organosilanes and/or organosiloxanes corresponding to the respective structural units as starting materials in the presence of acid or alkali or through copolymerization of co-hydrolyzates. Examples of the starting materials include chlorosilanes such as trimethylchlorosilane, triphenylchlorosilane, vinyldimethylchlorosilane, dimethyldichlorosilane, phenylmethyldichlorosilane, diphenyldichlorosilane, vinyltrichlorosilane, phenyltrichlorosilane, and methyltrichlorosilane; alkoxysilanes such as trimethylmethoxysilane, triphenylmethoxysilane, vinyldimethylmethoxysilane, divinyltetramethyldisiloxane, dimethyldimethoxysilane, phenylmethyldimethoxysilane, diphenyldimethoxysilane, vinyltrimethoxysilane, phenyltrimethoxysilane, and methyltrimethoxysilane.

The polyorgano-hydrogen-polysiloxane mixture, which is a component (Y) of the composition of the present invention, serves as a cross-linking agent for curing a resin composition during hydrosilylation with the polyorganosiloxane mixture of component (X) and is formed of one or more polyorgano-hydrogen-polysiloxanes each having two or more silicon-atom-bound hydrogen atoms in one molecule thereof.

No particular limitation is imposed on the polyorgano-hydrogen-polysiloxane, and the same species as exemplified in relation to component (B) of the curable resin composition may be employed.

In a conventional addition-polymerized silicone resin, component (Y) is generally employed in such an amount that the ratio by mole of silicon-atom-bound hydrogen atoms to vinyl groups is adjusted to 1.5 or higher. A study carried out by the present inventors has revealed that the long-term heat resistance and light resistance of the cured product is likely to decrease, and the product is more readily discolored, as the ratio by mole of silicon-atom-bound hydrogen atoms to vinyl groups increases, and that this tendency is very clear particularly when the mole ratio exceeds 1.2. Thus, the amount of polyorgano-hydro-polysiloxane, which is component (Y), is regulated such that the ratio by mole of silicon-atom-bound hydrogen atoms in component (Y) to vinyl groups in polyorganosiloxane (component (X)) is adjusted to about 0.8 to about 1.2, preferably 0.9 to 1.1. Through such control, a cured product which is excellent in heat resistance and light resistance can be obtained.

The polyorganosiloxane mixture (component (X)) and the polyorgano-hydrogen-polysiloxane mixture (component (Y)) employed in the present invention preferably have a molecular weight of about 500 to about 10,000, from the viewpoints of compatibility and viscosity. The viscosity is preferably about 0.1 to about 30 Pa·s in the mixture of components (X) and (Y) from the viewpoint of workability.

The addition reaction catalyst, which is component (Z) of the composition of the present invention, is a catalyst which is generally used to accelerate addition reaction between a hydrogen-atom-bound silicon atom and a hydrocarbon having a multiple bond. In the present invention, the catalyst is used to accelerate hydrosilylation between a vinyl group in component (X) and a hydrogen atom directly bonded to a silicon atom in component (Y). The addition reaction catalyst is preferably a platinum-group metal catalyst. Details of the platinum-group metal catalyst are described in relation to the hydrosilylation catalyst (component (C)) of the aforementioned curable resin composition.

Notably, the addition reaction catalyst may be used in a catalytic amount. Generally, the catalyst is preferably employed an amount, as reduced to platinum-group metal, of about 1 to about 500 ppm with respect to the total mass of components (X) and (Y), particularly about 5 to about 50 ppm.

If required, to the composition for encapsulating an LED of the present invention, an inorganic filler or a phosphor material may be added. Examples of the inorganic filler include microcrystalline silica, titanium oxide, and zirconium oxide. The inorganic filler may be employed so long as the transparency of the composition is not impaired. When a phosphor material for modulating emission wavelength is added to the composition, the composition can be employed as an encapsulating material for white LEDs. No particular limitation is imposed on the phosphor, and a customary phosphor such as YAG is employed.

Suitable curing conditions for yielding a desired cured product include a curing temperature of 50° C. to 200° C., preferably 80° C. to 150° C.; and a curing time of 30 min to 180 min. The curing temperature is selected from an appropriate range depending on the type of the catalyst employed.

The LED package of the present invention may be produced through coating a light-emitting device preferably having a main emission peak at 550 nm or shorter with the composition of the present invention, followed by heating at a predetermined temperature for curing.

Details of the light-emitting device are described in relation to the aforementioned encapsulated optical device.

To such a light-emitting device, an electrode is attached through a known technique, and the attached electrode is electrically connected to a lead terminal or a similar part through various techniques. The electrical connection member preferably has appropriate properties; for example, good ohmic and mechanical connectability to an electrode of the light-emitting device, and an example of the connection member is bonding wire made of, for example, gold, silver, copper, platinum, aluminum, or an alloy thereof. Alternatively, a conductive adhesive formed of a resin containing a conductive filler such as silver or carbon may also be employed. Among them, aluminum wire and gold wire are preferably employed, from the viewpoint of good workability.

The lead terminal employed in the LED package of the present invention preferably has good electrical conductivity and connectability to an electrical connection member such as bonding wire. The lead terminal preferably has an electric resistance of 300 μΩ·cm or lower, more preferably 3 μΩ·cm or lower. Examples of the material for the lead terminal include iron, copper, copper-iron, copper-tin, and those plated with silver, nickel, etc. In order to attain favorable light dispersion, the gloss of the lead terminal may be appropriately modified.

The LED package of the present invention may be produced through coating an light-emitting device with the composition of the present invention and heating the composition for curing. As used herein, the term “coating” refers not only to direct encapsulating of the light-emitting device but also to indirect coating. Specifically, a light-emitting device may be encapsulated with the composition of the present invention through various techniques, or a light-emitting device may be encapsulated with glass or a conventional encapsulating resin such as epoxy resin, acrylic resin, urea resin, or imide resin, followed by over-coating the surface or the periphery of the pre-encapsulated product with the composition of the present invention. Alternatively, a light-emitting device may be encapsulated with the curable resin composition of the present invention, followed by molding with a conventionally employed material such as epoxy resin, acrylic resin, urea resin, or imide resin. Through employment of any of the aforementioned techniques, a variety of effects such as a lens effect can be imparted to the cured product based on the difference in refractive index or specific weight.

Details of the encapsulating method and the type and applications of the LED of the present invention are described in relation to the aforementioned encapsulated optical device of the present invention.

### EXAMPLES

Hereinafter, the present invention is described in detail by Examples, Comparative Examples, and Application Examples. However, the present invention is not limited thereto at all.

It is to be noted that the methods for measurement of respective properties in the Application Examples are described below.

### (1) Light Transmittance

Light transmittance was measured at 400 nm with the use of a UV-1650PC spectrophotometer made by the Shimadzu Corporation.

(2) Retention of Illuminance after an Electricity-Transmitted Test at a High Temperature

There were measured the illuminance value integrated in an encapsulated LED package at the initial stage and the irradiance value after having carried out an electricity-transmitted test while conducting a current of 20 mA in an oven maintained at 100° C. for 1000 hours by means of a USR-30 spectroradiometer manufactured by Ushio Inc., and the retention of illuminance was calculated by the following formula.

Retention (%) of illuminance=[(Irradiance value after testing)/(Irradiance value at the initial stage)]×100

### (3) Refractive Index

The refractive index for a plate of a cured resin was measured according to JIS K7105, which is the same plate used in the measurement of the light transmittance.

### (4) Weather Resistance

In order to determine weather resistance for the same plate used in the measurement of the light transmittance, ultraviolet light of 365 nm (600 mV/cm²) was radiated for 10 hours, with the use of an Acticure 4000 ultraviolet radiator manufactured by EXFO company, and then its light transmittance (%) was measured at 400 nm to use as an indicator of weather resistance.

### (5) Heat Resistance

In order to determine heat resistance for the same plate used in the measurement of the light transmittance, the plate was placed in an oven maintained at 150° C. for 72 hours, then its light transmittance (%) was measured at 400 nm, to use as an indicator of heat resistance.

### (6) Condition of Encapsulated Portions in the LED

The condition of the encapsulated portions in the LED was assessed by finger touching, and if a touched portion was sticky or rough, the condition was denoted as “x”, and if a touched portion was neither sticky nor rough, it was denoted as “∘”.

### Example 1

65.4 g (0.33 mole) of phenyltrimethoxysilane, 24.3 g (0.10 mole) of diphenyldimethoxysilane, 30.2 g (0.29 mole) of trimethylmethoxysilane, 41.5 g (0.28 mole) of vinyltrimethoxysilane and 300 ml of acetic acid were charged and polymerized at 80° C. for 10 hours. Then, 300 ml of toluene was added to obtain a toluene solution containing a polyorganosiloxane mixture. The solution was washed 5 times with 300 ml water each time. Thereafter, toluene was removed by distillation under a reduced pressure to obtain a polyorganosiloxane having the average compositional proportion corresponding to the following formula.

The polyorganosiloxane was named as “Resin 1”. The digit at the right side of each structural unit shows a respective molar proportion.

((CH₃)₃SiO_{1/2})_{0.29}, (Ph₂SiO_{2/2})_{0.10}, (CH═CH₂SiO_{3/2})_{0.28}, (PhSiO_{3/2})_{0.33}.

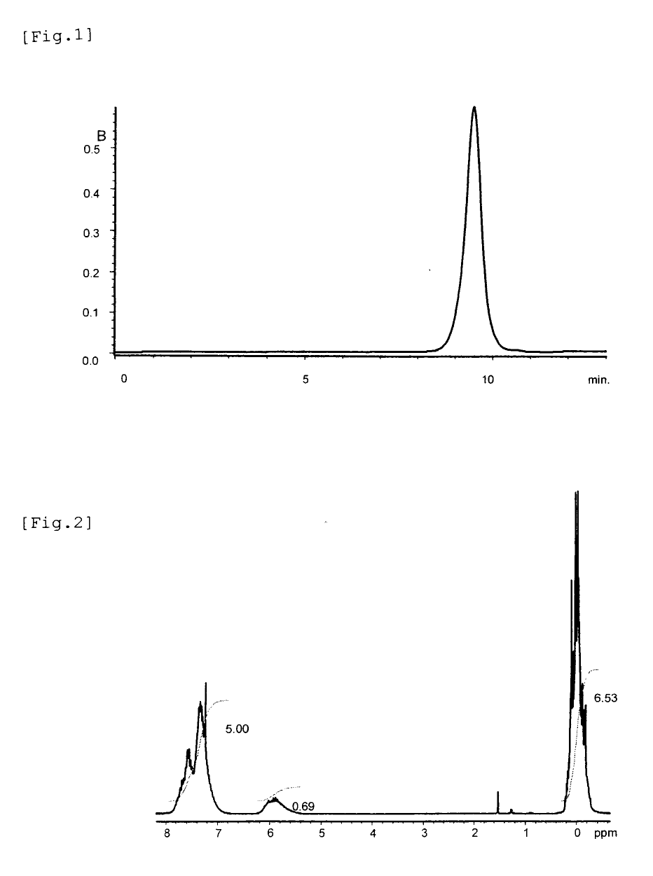

The GPC curve for the obtained polyorganosiloxane is shown in FIG. 1.

### Example 2

77.3 g (0.39 mole) of phenyltrimethoxysilane, 26.7 g (0.11 mole) of diphenyldimethoxysilane, 35.4 g (0.34 mole) of trimethylmethoxysilane, 23.7 g (0.16 mole) of vinyltrimethoxysilane and 300 ml of acetic acid were charged and polymerized at 80° C. for 10 hours. Then, 300 ml of toluene was added to obtain a toluene solution containing a polyorganosiloxane mixture. The solution was washed 5 times with 300 ml water each time. Thereafter, toluene was removed by distillation under a reduced pressure to obtain a polyorganosiloxane having the average compositional proportion corresponding to the following formula. The polyorganosiloxane was named as “Resin 2”. The digit at the right side of each structural unit shows a respective molar proportion.

((CH₃)₃SiO_{1/2})_{0.34}, (Ph₂SiO_{2/2})_{0.11}, (CH═CH₂SiO_{3/2})_{0.16}° (PhSiO_{3/2})_{0.39}

### Example 3

79.3 g (0.40 mole) of phenyltrimethoxysilane, 36.4 g (0.15 mole) of diphenyldimethoxysilane, 26.0 g (0.25 mole) of trimethylmethoxysilane, 22.2 g (0.15 mole) of vinyltrimethoxysilane, 6.6 g (0.05 mole) of vinylmethyldimethoxysilane, 1 ml of acetyl chloride and 300 ml of acetic acid were charged and polymerized at 80° C. for 10 hours to obtain a polyorganosiloxane mixture. Then, 300 ml of toluene was added to the polyorganosiloxane mixture to obtain a toluene solution.

The toluene solution was washed 5 times with 300 ml water each time. The toluene solution was dried using anhydrous sodium sulfate, followed by removing the anhydrous sodium sulfate by filtration.

Then, 48.4 g (0.30 mole) of hexamethyldisilazane was added to the toluene solution, followed by refluxing for 8 hours to cap silanol groups. Obtained solution was washed 5 times with 300 ml of water each time, followed by removing toluene by distillation under a reduced pressure to obtain a polyorganosiloxane having the average compositional proportion corresponding to the following formula. The polyorganosiloxane was named as “Resin 3”. The digit at the right side of each structural unit shows a respective molar proportion.

((CH₃)₃SiO_{1/2})_{0.25}, (Ph₂SiO_{2/2})_{0.15}, (CH═CH₂SiO_{3/2}) 0.15, (PhSiO_{3/2})_{0.40}, (CH═CH₂CH₃SiO_{2/2})_{0.05}

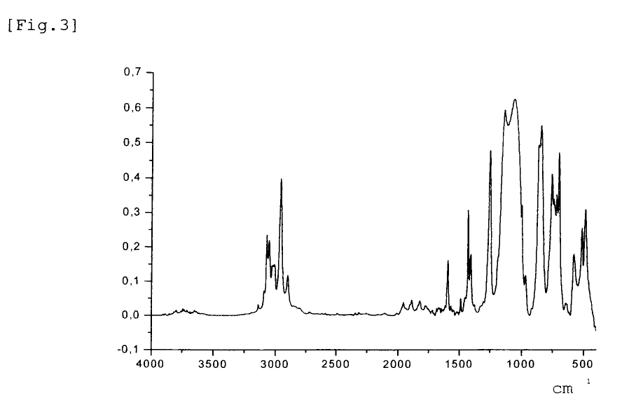

An ¹H-NMR chart and an IR chart for the obtained polyorganosiloxane are shown in FIG. 2 and FIG. 3, respectively.

### Example 4

65.4 g (0.33 mole) of phenyltrimethoxysilane, 43.7 g (0.18 mole) of diphenyldimethoxysilane, 30.2 g (0.29 mole) of trimethylmethoxysilane, 29.6 g (0.20 mole) of vinyltrimethoxysilane, 200 ml of acetic acid and 200 ml of toluene were charged and polymerized at 80° C. for 10 hours to obtain a toluene solution containing a polyorganosiloxane mixture.

Obtained toluene solution was washed 5 times with 300 ml of water each time. The toluene solution was dried using anhydrous sodium sulfate, followed by removing the anhydrous sodium sulfate by filtration. Then, 24.2 g (0.15 mole) of hexamethyldisilazane and 16.3 g (0.15 mole) of trimethylchlorosilane were added to the toluene solution, followed by refluxing for 8 hours to cap silanol groups.

Obtained solution was washed 5 times with 300 ml of water each time, followed by removing toluene by distillation under a reduced pressure to obtain a polyorganosiloxane having the average compositional proportion corresponding to the following formula.

The polyorganosiloxane was named as “Resin 4”. The digit at the right side of each structural unit shows a respective molar proportion.

((CH₃)₃SiO_{1/2})_{0.29}, (Ph₂SiO_{2/2})_{0.18}, (CH═CH₂SiO_{3/2})_{0.20}, (PhSiO_{3/2})_{0.33}

### Comparative Example 1

79.3 g (0.40 mole) of phenyltrimethoxysilane, 48.6 g (0.20 mole) of diphenyldimethoxysilane, 30.2 g (0.29 mole) of trimethylmethoxysilane, 16.3 g (0.11 mole) of vinyltrimethoxysilane and 300 ml of acetic acid were charged and polymerized at 80° C. for 10 hours, followed by adding 300 ml of toluene to obtain a toluene solution containing a polyorganosiloxane mixture. Obtained solution was washed 5 times with 300 ml of water each time, followed by removing toluene by distillation under a reduced pressure to obtain a polyorganosiloxane having the average compositional proportion corresponding to the following formula. The polyorganosiloxane was named as “Resin 5”. The digit at the right side of each structural unit shows a respective molar proportion.

((CH₃)₃SiO_{1/2})_{0.29}, (Ph₂SiO_{2/2})_{0.20}, (CH═CH₂SiO_{3/2})_{0.11}, (PhSiO_{3/2})_{0.40}

The structural unit (CH═CH₂SiO_{3/2}) in the “Resin 5” is out of the scope of the polyorganosiloxane in the present invention.

### Application Example 1

70 parts by mass of a commercially available polyphenyl (dimethylhydrogensiloxy)siloxane (a number average molecular weight of 1,000) represented by the Formula (IV) was added to 100 parts by mass of the “Resin 1”, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained. Thereafter, the resin composition was poured around a stem mounted with an LED chip with a peak wave length of 465 nm, and was cured while heating up at 150° C. for 180 minutes. As a result, a transparent LED package was obtained free from tackiness and cracks in encapsulated portions. Luminescence was measured when electric current of 20 mA was transmitted through the LED package. The same composition was poured at both sides of a spacer with the thickness of 2 mm which is sandwiched between glass plates to cure under the same conditions. Transmittance, refractive index, weather resistance, and heat resistance were measured at 400 nm for obtained resin plate. Further, condition was observed in the encapsulated portions. Table 1 shows the results of measurements.

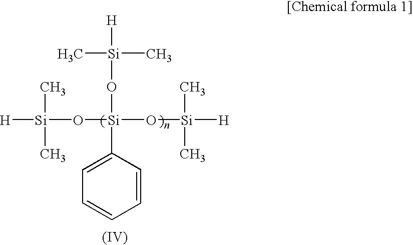

### Application Example 2

50 parts by mass of a commercially available methylhydrogensiloxane-phenylmethylsiloxane copolymer (a number average molecular weight of 1,100) represented by the Formula (V) was added to 100 parts by mass of the “Resin 2”, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained.

The resin composition was cured to prepare a cured product and an LED package by the same method as in the Application Example 1, and respective properties were measured. Table 1 shows the results of measurements.

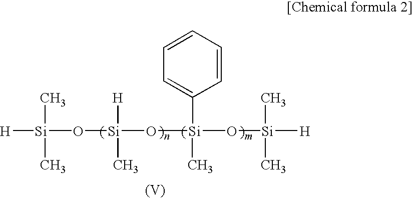

### Application Example 3

30 parts by mass of a commercially available 1,3,5,7-tetramethyl cyclotetrasiloxane was added to 100 parts by mass of the “Resin 3”, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained.

The resin composition was cured to prepare a cured product and an LED package by the same method as in the Application Example 1, and respective properties were measured. Table 1 shows the results of measurements.

### Application Example 4

30 parts by mass of a polyphenyl(dimethylhydrogensiloxy)siloxane (a number average molecular weight of 1,000) represented by the above formula (IV) and 30 parts by mass of methylhydrogensiloxane-phenylmethylsiloxane copolymer (a number average molecular weight of 1,100) represented by the above the formula (V) were added to 100 parts by mass of the “Resin 4”, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained.

The resin composition was cured to prepare a cured product and an LED package by the same method as in the Application Example 1, and respective properties were measured. Table 1 shows the results of measurements.

### Comparative Application Example 1

30 parts by mass of a commercially available polyphenyl (dimethylhydrogensiloxy)siloxane (a number average molecular weight of 1,000) represented by the above formula (IV) was added to 100 parts by mass of the “Resin 5”, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained. The resin composition was cured to prepare a cured product and an LED package by the same method as in the Application Example 1, and respective properties were measured. Table 2 shows the results of measurements. Encapsulated portions in the LED package were soft, slightly sticky, and easy to scratch.

### Comparative Application Example 2

50 parts by mass of a commercially available methylhydrogensiloxane-phenylmethylsiloxane copolymer (a number average molecular weight of 1,100) represented by the above the formula (V) was added to 100 parts by mass of a commercially available vinyl group-terminated polydimethyl siloxane (a number average molecular weight of 770) represented by the formula (VI) shown hereinafter, followed by adding a complex of platinum-1,3-divinyl-1,1,3,3-tetramethyldisiloxane in the amount of 30 ppm as platinum, which is a catalyst. Obtained composition was sufficiently stirred to mix and to remove foams, resulting in that a resin composition was obtained. The resin composition was cured to prepare a cured product and an LED package by the same method as in the Application Example 1, and respective properties were measured. Table 2 shows the results of measurements. Encapsulated portions in the LED package were soft, slightly sticky, and easy to scratch.

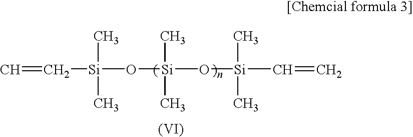

### Comparative Application Example 3

80 parts by mass of 4-methylhexahydrophthalic anhydride as a curing agent and 1 part by mass of methyltributylphosphonium dimethylphosphate as an accelerator for curing were added to 100 parts by mass of a diglycidyl ether of a hydrogenated bisphenol A as an epoxy resin.

Obtained composition was sufficiently stirred to mix and to remove foams, resulting in that a resin composition was obtained. The resin composition was cured to prepare a cured product by the same method as in the Application Example 1, and respective properties were measured.

Table 2 shows the results of measurements.

[Table 1]

TABLE 1

| | Application | Application | Application | Application |
|---|---|---|---|---|
| | Example 1 | Example 2 | Example 3 | Example 4 |
| Light transmittance (%) | 90 | 90 | 90 | 90 |
| Light transmittance after a | 90 | 90 | 90 | 90 |
| test for weather resistance (%) | | | | |
| Light transmittance after a | 90 | 90 | 90 | 90 |
| test for heat resistance (%) | | | | |
| Refractive index | 1.52 | 1.50 | 1.50 | 1.51 |
| Condition of encapsulated | ∘ | ∘ | ∘ | ∘ |
| portions | | | | |
| Retention (%) of illuminance | 92 | 92 | 93 | 92 |
| after an electricity- | | | | |
| transmitted test at a high | | | | |
| temperature | | | | |

[Table 2]

TABLE 2

| | Comparative | Comparative | Comparative |
|---|---|---|---|
| | Application | Application | Application |
| | Example 1 | Example 2 | Example 3 |
| Light transmittance (%) | 90 | 91 | 88 |
| Light transmittance after a | 90 | 91 | 57 |
| test for weather resistance | | | |
| (%) | | | |
| Light transmittance after a | 90 | 90 | 78 |
| test for heat resistance (%) | | | |
| Refractive index | 1.50 | 1.43 | 1.50 |
| Condition of encapsulated | x | x | ∘ |
| portions | | | |
| Retention (%) of illuminance | 92 | 93 | 35 |
| after an electricity- | | | |
| transmitted test at a high | | | |
| temperature | | | |

As evident from Tables 1 and 2, the cured product and LED package which are obtained using the curable resin compositions in the present invention show excellent light transmittance, weather resistance, and heat resistance, and refractive index and hardness are improved.

Hereinafter, there are shown Synthesis Examples 1-3, Comparative Synthesis Examples 1-2, Examples 5-7, and Comparative Examples 2-5. It is to be noted that the methods for measurement of respective properties in the Examples and Comparative Synthesis Examples are described below.

(1)Light transmittance: It was measured at 400 nm with the use of a UV-1650PC spectrophotometer made by the Shimadzu Corporation.
(2) Retention of illuminance: There were measured the illuminance value integrated in an encapsulated LED package at the initial stage and the irradiance value after having carried out an electricity-transferred test while conducting a current of 20 mA in an oven maintained at 100° C. for 1000 hours by means of a USR-30 spectroradiometer manufactured by Ushio Inc., and the retention of illuminance was calculated by the following formula.

Retention (%) of illuminance=[(Irradiance value after testing)/(Irradiance value at the initial stage)]×100

(3) Refractive index: It was measured according to JIS K7105.
(4) Light resistance: Ultraviolet ray was irradiated for 1000 hours using a black light, and then light transmittance was measured at 400 nm.
(5) Heat resistance: Sample was placed in a thermostatic oven maintained at 150° C. for 72 hours, then light transmittance was measured at 400 nm.

### Synthesis Example 1

20.8 g (0.20 mole) of trimethylmethoxysilane, 24.3 g (0.1 mole) of dimethyldimethoxysilane, 83.2 g (0.42 mole) of methyltrimethoxysilane, 8.9 g (0.06 mole) of vinyltrimethoxysilane, 20.5 g (0.11 mole) of divinyltetramethyldisiloxane, and 500 g of acetic acid were charged and polymerized at 110° C. for 10 hours, followed by adding 500 g of toluene and washing by 500 ml of water 5 times to obtain a toluene solution of a polyorganosiloxane mixture. The solution was subjected to distillation at a reduced pressure to remove toluene and to obtain a mixture of the polyorganosiloxane having the average compositional proportion represented by the following formula corresponding to the component (X). The polyorganosiloxane was named as “Resin A”. The digit at the right side of each structural unit shows a respective molar proportion.

((CH₃)₃SiO_{1/2}) 0.20, ((CH₃)₂SiO_{2/2}) 0.1, (CH₃SiO_{3/2}) 0.42, (CH═CH₂SiO_{3/2})0.06, (CH═CH₂(CH₃)₂SiO_{1/2}) 0.22

### Synthesis Example 2

The same reaction as in the Synthesis Example 1 was carried out using 15.6 g (0.15 mole) of trimethylmethoxysilane, 24.4 g (0.1 mole) of diphenyldimethoxysilane, 93.2 g (0.47 mole) of phenyltrimethoxysilane, 20.7 g (0.14 mole) of vinyltrimethoxysilane, 13.0 g (0.07 mole) of divinyltetramethyldisiloxane to obtain a mixture of a polyorganosiloxane having the average compositional proportion represented by the following formula corresponding to the component (X). The polyorganosiloxane was named as “Resin B”. The digit at the right side of each structural unit shows a respective molar proportion.

((CH₃)₃SiO_{1/2}) 0.15, (Ph₂SiO_{2/2}) 0.1, (PhSiO_{3/2}) 0.47, (CH═CH₂SiO_{3/2})0.14, (CH═CH₂(CH₃)₂SiO_{1/2}) 0.14

### Synthesis Example 3

The same reaction as in the Synthesis Example 1 was carried out using 20.8 g (0.20 mole) of trimethylmethoxysilane, 19.5 g (0.08 mole) of diphenyldimethoxysilane, 4.8 g (0.04 mole) of dimethyldimethoxysilane, 93.2 g (0.47 mole) of phenyltrimethoxysilane, 23.7 g (0.16 mole) of vinyltrimethoxysilane, 4.7 g (0.025 mole) of divinyltetramethyldisiloxane to obtain a mixture of a polyorganosiloxane having the average compositional proportion represented by the following formula corresponding to the component (X). The polyorganosiloxane was named as “Resin C”. The digit at the right side of each structural unit shows a respective molar proportion.

((CH₃)₃SiO_{1/2}) 0.20, (Ph₂SiO_{2/2}) 0.08, ((CH₃)₂SiO_{2/2}) 0.04, (PhSiO_{3/2}) 0.47, (CH═CH₂SiO_{3/2}) 0.16, (CH═CH₂(CH₃)₂SiO_{1/2}) 0.05

### Comparative Synthesis Example 1

The same reaction as in the Synthesis Example 1 was carried out using 15.6 g (0.15 mole) of trimethylmethoxysilane, 24.4 g (0.1 mole) of diphenyldimethoxysilane, 93.2 g (0.47 mole) of phenyltrimethoxysilane, 4.4 g (0.03 mole) of vinyltrimethoxysilane, 46.4 g (0.125 mole) of divinyltetramethyldisiloxane to obtain a mixture of a polyorganosiloxane having the average compositional proportion represented by the following formula. The polyorganosiloxane was named as “Resin D”. The digit at the right side of each structural unit shows a respective molar proportion.

((CH₃)₃SiO_{1/2}) 0.15, (Ph₂SiO_{2/2}) 0.1, (PhSiO_{3/2}) 0.47, (CH═CH₂SiO_{3/2}) 0.03, (CH═CH₂(CH₃)₂SiO_{1/2}) 0.25

### Comparative Synthesis Example 2

The same reaction as in the Synthesis Example 1 was carried out using 15.6 g (0.15 mole) of trimethylmethoxysilane, 24.4 g (0.1 mole) of diphenyldimethoxysilane, 93.2 g (0.47 mole) of phenyltrimethoxysilane, 35.5 g (0.24 mole) of vinyltrimethoxysilane, 3.7 g (0.02 mole) of divinyltetramethyldisiloxane to obtain a mixture of a polyorganosiloxane having an average compositional proportion represented by the following formula. The polyorganosiloxane was named as “Resin E”. The digit at the right side of each structural unit shows a respective molar proportion.

((CH₃)₃SiO_{1/2}) 0.15, (Ph₂SiO_{2/2}) 0.1, (PhSiO_{3/2}) 0.47, (CH═CH₂SiO_{3/2})0.24, (CH═CH₂(CH₃)₂SiO_{1/2}) 0.04

### Example 5

21 parts by mass (the amount of SiH is 0.9 equivalent to vinyl group) of 1,3,5,7-tetramethylcyclotetrasiloxane which is a polyorgano hydrogenpolysiloxane was added to 100 parts by mass of the “Resin A”, followed by adding 50 ppm of a complex of platinum-1,3-divinyl-1,1,3,3-tetramethyldisiloxane which is a catalyst. Obtained composition was sufficiently stirred to mix and to remove foams, resulting in that a resin composition was obtained. Thereafter, the resin composition for encapsulating an LED was poured around a stem with an LED chip with a peak wave length of 465 nm, and was cured while heating up at 150° C. for 180 minutes. As a result, a transparent LED package was obtained free from cracks in encapsulated portions. Illuminance was measured when electric current of 20 mA was transmitted through the LED package. The composition was poured at both sides of a spacer with the thickness of 2 mm which is sandwiched between glass plates to cure under the same conditions of 150° C. for 180 minutes. Transmittance was measured at 400 nm for obtained resin plate, and IR spectra were obtained for identifying curability. As a result of identification of the absorption peak at 2100 cm⁻¹ derived from Si—H and the absorption peak at 1000 cm⁻¹ derived from vinyl group in the IR spectra obtained, the absorption peak derived from Si—H was not quite observed. Accordingly, it was confirmed that curing reaction was completed. Table 3 shows results.

### Example 6

36 parts by mass (the amount of SiH is 1.0 equivalent to vinyl group) of a polyphenyl(dimethylhydrogensiloxy)siloxane (a number average molecular weight of 1000) which is a polyorganohydrogenpolysiloxane was added to 100 parts by mass of the “Resin B”, followed by adding 50 ppm of a complex of platinum-1,3-divinyl-1,1,3,3-tetramethyldisiloxane which is a catalyst. Obtained composition was sufficiently stirred to mix and to remove foams, resulting in that a resin composition was obtained. An LED package and a cured product were prepared from the resin composition for encapsulating an LED by the same methods in the Example 5, and respective properties were measured. Table 3 shows results. As a result of identification of the absorption peak at 2100 cm⁻¹ derived from Si—H and the absorption peak at 1000 cm⁻¹ derived from vinyl group in IR spectra obtained, both absorption peaks were not quite observed. Accordingly, it was confirmed that curing reaction was completed.

### Example 7

14 parts by mass (the amount of SiH is 1.2 equivalent to vinyl group) of 1,3,5,7-tetramethylcyclotetrasiloxane which is a polyorganohydrogenpolysiloxane was added to 100 parts by mass of the “Resin C”, followed by adding 50 ppm of a complex of platinum-1,3-divinyl-,1,1,3,3-tetramethyldisiloxane which is a catalyst. Obtained composition was sufficiently stirred to mix and to remove foams, resulting in that a resin composition was obtained. An LED package and a cured product were prepared from the resin composition for encapsulating an LED by the same methods in the Example 5, and respective properties were measured. Table 3 shows results. As a result of identification of the absorption peak at 2100 cm⁻¹ derived from Si—H and the absorption peak at 1000 cm⁻¹ derived from vinyl group in IR spectra obtained, the absorption peak derived from vinyl group was not quite observed.

Accordingly, it was confirmed that curing reaction was completed.

### Comparative Example 2

37 parts by mass (the amount of SiH is 1.0 equivalent to vinyl group) of a polyphenyl(dimethylhydrogensiloxy)siloxane (a number average molecular weight of 1,000) represented by the above formula (IV) which is a polyorganohydrogenpolysiloxane was added to 100 parts by mass of the “Resin D”, followed by adding a complex of platinum-1,3-divinyl-1,1,3,3-tetramethyldisiloxane in the amount of 50 ppm, which is a catalyst. Obtained composition was sufficiently stirred to mix and to remove foams, resulting in that a resin composition was obtained. When the resin composition was handled at a room temperature, it gelled after viscosity has increased, resulting in that it was not able to carry out respective measurements.

### Comparative Example 3

36 parts by mass (the amount of SiH is 1.0 equivalent to vinyl group) of a polyphenyl(dimethylhydrogensiloxy)siloxane (a number average molecular weight of 1,000) represented by the above formula (IV) which is a polyorganohydrogenpolysiloxane was added to 100 parts by mass of the “Resin E”, followed by adding a complex of platinum-1,3-divinyl-1,1,3,3-tetramethyldisiloxane in the amount of 50 ppm, which is a catalyst. Obtained composition was sufficiently stirred to mix and to remove foams, resulting in that a resin composition was obtained. A cured product was prepared from the resin composition by the same methods in the Example 5, and IR spectra were measured. In the IR spectra, there are remained the absorption peak at 2100 cm⁻¹ derived from Si—H and the absorption peak at 1000 cm⁻¹ derived from vinyl group. Accordingly, it was confirmed that curing reaction was not completed.

### Comparative Example 4

37 parts by mass (the amount of SiH is 1.0 equivalent to vinyl group) of a polyphenyl(dimethylhydrogensiloxy)siloxane (a number average molecular weight of 1,000) represented by the above formula (IV) which is a polyorganohydrogenpolysiloxane was added to 100 parts by mass of the “Resin D”, followed by adding 0.01 part by mass of ethylcyclohexylalcohol which is a retardant for curing, and followed by adding a complex of platinum-1,3-divinyl-1,1,3,3-tetramethyldisiloxane in the amount of 50 ppm, which is a catalyst. Obtained composition was sufficiently stirred to mix and to remove foams, resulting in that a resin composition was obtained. An LED package and a cured product were prepared from the resin composition by the same methods in the Example 5, and respective properties were measured. Table 3 shows results. As a result of identification of the absorption peak at 2100 cm⁻¹ derived from Si—H and the absorption peak at 1000 cm⁻¹ derived from vinyl group in IR spectra obtained, both absorption peaks were not quite observed. Accordingly, it was confirmed that curing reaction was completed.

### Comparative Example 5

50 parts by mass (the amount of SiH is 1.4 equivalent to vinyl group) of a polyphenyl(dimethylhydrogensiloxy)siloxane (a number average molecular weight of 1,000) represented by the above formula (IV) which is a polyorganohydrogenpolysiloxane was added to 100 parts by mass of the “Resin B”, followed by adding a complex of platinum-1,3-divinyl-1,1,3,3-tetramethyldisiloxane in the amount of 50 ppm, which is a catalyst. Obtained composition was sufficiently stirred to mix and to remove foams, resulting in that a resin composition was obtained. An LED package and a cured product were prepared from the resin composition by the same methods in the Example 5, and respective properties were measured. Table 3 shows results. As a result of identification of the absorption peak at 2100 cm⁻¹ derived from Si—H and the absorption peak at 1000 cm⁻¹ derived from vinyl group in IR spectra obtained, the absorption peak derived from vinyl group was not quite observed. Accordingly, it was confirmed that curing reaction was completed.

[Table 3]

TABLE 3

| | | | | Compara- | Compara- |
|---|---|---|---|---|---|
| | Exam- | Exam- | Exam- | tive | tive |
| | ple 5 | ple 6 | ple 7 | Example 4 | Example 5 |
| Light transmittance | 91% | 90% | 90% | 90% | 91% |
| (400 nm) | | | | | |
| Weather | 91% | 90% | 90% | 85% | 86% |
| resistance | | | | | |
| Heat | 91% | 90% | 90% | 84% | 82% |
| resistance | | | | | |
| Refractive | 1.42 | 1.52 | 1.48 | 1.52 | 1.52 |
| Index | | | | | |
| Retention of | 99% | 94% | 94% | 81% | 83% |
| illuminance | | | | | |
| after an electricity- | | | | | |
| transmitted test | | | | | |
| at a high | | | | | |
| temperature | | | | | |

It is shown in Table 3 that a cured product and LED package which have excellent heat resistance and light resistance can be obtained using an encapsulating composition for an LED of the present invention.

### INDUSTRIAL APPLICABILITY

According to the present invention, there can be provided a silicone-based curable resin composition, which forms a cured product having well-balanced properties including excellent transparency, high refractive index, weather resistance, and heat resistance and serving as an encapsulating material for an optical device, particularly a blue-light LED or a UV LED. Also provided is an optical device encapsulated with the composition.

The invention can also provide a composition for encapsulating an LED, which provides a cured product having high transparency, heat resistance, and light resistance, which characteristics are desired for encapsulating, among others, LEDs emitting blue to UV light and white light-emitting devices and which can be readily handled.

1. A polyorganosiloxane having on average two or more vinyl groups in one molecule thereof and represented by formula (I), which indicates structural units and average compositional proportion:
(R²₃SiO_{1/2})ₐ,(Ph₂SiO_{2/2})_{b},(R¹SiO_{3/2})_{c},(PhSiO_{3/2})_{d},(R¹R²SiO_{2/2})ₑ (I)
wherein “a” to “e” represent compositional proportions by mole, satisfying the conditions: 0.15≦a≦0.4, 0.1≦b≦0.2, 0.15≦c≦0.4, 0.2≦d≦0.4, 0≦e≦0.2, and “a+b+c+d+e”=1; R¹ represents a vinyl group; R² represents a methyl group or a phenyl group; and Ph denotes a phenyl group.

2. The polyorganosiloxane as claimed in claim 1, which is produced through condensation of an alkoxysilane mixture represented by following formula (II):
R²₃SiOR,Ph₂Si(OR)₂, R¹Si(OR)₃,PhSi(OR)₃ (II)
wherein R¹ represents a vinyl group, R² represents a methyl group or a phenyl group, R represents a C1 to C6 alkyl group, and Ph denotes a phenyl group in an active solvent.

3. The polyorganosiloxane as claimed in claim 2, wherein the active solvent is a carboxylic acid in the form of a sole component or a mixture of a carboxylic acid and one or more solvents selected from the group consisting of an aliphatic carboxylic acid ester, an ether, an aliphatic ketone, and an aromatic solvent.

4. The polyorganosiloxane containing a first polyorganosiloxane as claimed in claim 2 and a second polyorganosiloxane, said second polyorganosiloxane being produced through condensation of an alkoxysilane mixture selected from the group consisting of the alkoxysilane mixtures represented by formula (II) characterized in that the compositional proportion of structural units of the second polyorganosiloxane differs from those given in formula (I).

5. The polyorganosiloxane as claimed in claim 2, wherein the condensation is performed at temperatures of 20 to 150° C.

6. The polyorganosiloxane as claimed in claim 2, wherein the condensation is performed in the presence of acetyl chloride as a catalyst.

7. The polyorganosiloxane as claimed in claim 2, wherein end silanol groups are terminated with one or more silane compounds selected from the group consisting of hexamethyldisilazane, trimethylchlorosilane, triethylchlorosilane, triphenylchlorosilane, and dimethylvinylchlorosilane.

8. The polyorganosiloxane as claimed in claim 2, wherein the ratio of carboxylic acid to organic solvent employed as the active solvent is 1:10 to 10:1 (ratio by mass).

9. A curable resin composition comprising (A) a polyorganosiloxane as claimed in claim 1, (B) a polyorgano-hydrogen-polysiloxane having on average two or more hydrogen atoms connected to a silicon atom in one molecule thereof, and (C) a hydrosilylation catalyst.

10. The curable resin composition as claimed in claim 9, wherein the polyorgano-hydrogen-polysiloxane which is the component (B) contains a (CH₃)₂SiHO_{1/2} unit and/or a CH₃SiHO_{2/2} unit.

11. The curable resin composition as claimed in claim 9, wherein the polyorgano-hydrogen-polysiloxane which is the component (B) has at least one phenyl group in one molecule thereof.

12. The curable resin composition as claimed in claim 9, wherein the amount of component (B) with respect to component (A) is such that the ratio by mole of hydrogen atoms connected to a silicon atom in component (B) to vinyl groups in component (A) is adjusted to 0.5 to 2.0.

13. The curable resin composition as claimed in claim 9, wherein the hydrosilylation catalyst which is the component (C) is a platinum-group metal catalyst.

14. The curable resin composition as claimed in claim 9, which forms a cured product having a refractive index of 1.5 or higher.

15. The curable resin composition as claimed in claim 9, which is prepared for encapsulating an LED.

16. An optical device encapsulated with a curable resin composition as claimed in claim 9.

17. The optical device as claimed in claim 16, which is an LED.

18. A composition for encapsulating an LED, comprising:
(X) a polyorganosiloxane mixture having on average two or more vinyl groups in one molecule thereof and represented by formula (III), which indicates structural units and average compositional proportion:
(R³₃SiO_{1/2})_{f},(R⁴₂SiO_{2/2})_{g},(R⁵SiO_{3/2})ₕ,(CH═CH₂SiO_{3/2})ᵢ,(CH═CH₂(CH₃)₂SiO_{1/2})ⱼ (III)
wherein “f” to “j” represent compositional proportions by mole, satisfying the conditions: 0.05≦f≦0.25, 0.05≦g≦0.15, 0.30≦h≦0.65, 0.05≦I≦0.25, 0.05≦j≦0.25, and “f+g+h+I+j”=1; and R³ to R⁵, which may be identical to or different from one another, each represent a methyl group or a phenyl group;
(Y) a polyorgano-hydrogen-polysiloxane mixture having on average two or more hydrogen atoms connected to a silicon atom in one molecule thereof, and
(Z) an addition reaction catalyst.

19. The composition for encapsulating an LED claimed in claim 18, wherein the ratio “i”:“j” in component (X) is 1:4 to 4:1.

20. The composition for encapsulating an LED as claimed in claim 18, wherein the amount of component (Y) with respect to component (X) is such that the ratio by mole of hydrogen atoms connected to a silicone atom in component (Y) to vinyl groups in component (X) is adjusted to 0.8 to 1.2.

21. The composition for encapsulating an LED as claimed in any claim 18, wherein the addition reaction catalyst which is the component (Z) is a platinum-group metal catalyst.

22. An LED encapsulated with a composition for encapsulating an LED as claimed in claim 18.
